(19) United States
(12) Patent Application Publication
(10) Pub. No.: US 2021/0103357 A1
(43) Pub. Date: Apr. 8, 2021

(54) DRIVING METHOD FOR REDUCING EMI OF TOUCH DISPLAY PANEL

(71) Applicant: HIMAX TECHNOLOGIES LIMITED, Tainan City (TW)

(72) Inventors: Yaw-Guang CHANG, Tainan City (TW); Guan-Ying HUANG, Tainan City (TW); Chang-Hui LIN, Tainan City (TW)

(21) Appl. No.: 16/712,967

(22) Filed: Dec. 12, 2019

Related U.S. Application Data
(60) Provisional application No. 62/909,788, filed on Oct. 3, 2019.

(51) Int. Cl. G06F 3/044; G06F 3/041

(52) U.S. Cl. CPC G06F 3/0443; G06F 3/04166; G06F 3/0412

(57) ABSTRACT

A driving method for reducing EMI of a touch display panel is provided. The touch display panel includes a common electrode layer. The driving method includes: applying a direct current (DC) voltage to the common electrode layer during a display period of the touch display panel; and applying a touch sensing signal to the common electrode layer during a touch sensing period of the touch display panel. The waveform of the touch sensing signal is a triangle wave, a sine wave, or the sine wave truncated by a window function.

### CROSS-REFERENCE TO RELATED APPLICATION

This application claims priority to US Provisional Application Ser. No. 62/909,788, filed Oct. 3, 2019, which is herein incorporated by reference.

### BACKGROUND

### Field of Invention

The present invention relates to a driving method of touch display panel. More particularly, the present invention relates to a driving method for reducing EMI of in-cell touch display panel.

### Description of Related Art

In the field of capacitive touch detection, as the smartphones become thinner and lighter, the structure of capacitive touch display panel is progresses from the capacitive touch display panel with filmed ITO to an on-cell capacitive touch display panel or even an in-cell capacitive touch display panel. Regarding the in-cell capacitive touch display panel, a common electrode (VCOM) layer of the in-cell capacitive touch display panel is utilized to detect touch events. When detecting the touch events, a square wave is generally applied to the common electrode (VCOM) layer so as to perform touch detection. However, the square wave generates severe electromagnetic interference (EMI) which is undesired especially for vehicle products because the EMI standard of the vehicle products is very strict.

### SUMMARY

The present invention provides a driving method for reducing EMI of a touch display panel. The touch display panel includes a common electrode layer. The driving method includes: applying a direct current (DC) voltage to the common electrode layer during a display period of the touch display panel; and applying a touch sensing signal to the common electrode layer during a touch sensing period of the touch display panel. The waveform of the touch sensing signal is a triangle wave.

In accordance with one or more embodiments of the invention, the touch display panel is an in-cell touch display panel.

In accordance with one or more embodiments of the invention, the touch display panel is a self-capacitive touch display panel or a mutual-capacitive touch display panel.

The present invention further provides a driving method for reducing EMI of a touch display panel. The touch display panel includes a common electrode layer. The driving method includes: applying a direct current (DC) voltage to the common electrode layer during a display period of the touch display panel; and applying a touch sensing signal to the common electrode layer during a touch sensing period of the touch display panel. The waveform of the touch sensing signal is a sine wave.

In accordance with one or more embodiments of the invention, the touch display panel is an in-cell touch display panel.

In accordance with one or more embodiments of the invention, the touch display panel is a self-capacitive touch display panel or a mutual-capacitive touch display panel.

The present invention further provides a driving method for reducing EMI of a touch display panel. The touch display panel includes a common electrode layer. The driving method includes: applying a direct current (DC) voltage to the common electrode layer during a display period of the touch display panel; and applying a touch sensing signal to the common electrode layer during a touch sensing period of the touch display panel. The waveform of the touch sensing signal is a sine wave truncated by a window function.

In accordance with one or more embodiments of the invention, the touch display panel is an in-cell touch display panel.

In accordance with one or more embodiments of the invention, the touch display panel is a self-capacitive touch display panel or a mutual-capacitive touch display panel.

In accordance with one or more embodiments of the invention, the window function has a shape other than a rectangular shape, such that the touch sensing signal is gradually attenuated from a center portion to both ends of the touch sensing signal.

### BRIEF DESCRIPTION OF THE DRAWINGS

The invention can be more fully understood by reading the following detailed description of the embodiment, with reference made to the accompanying drawings as follows:

FIG. 1 illustrates a structural drawing of a touch display panel according to some embodiments of the present invention.

FIG. 2 illustrates driving method for reducing EMI of the touch display panel according to some embodiments of the present invention.

FIG. 3 illustrates a drawing showing a waveform of a voltage applied to the common electrode (VCOM) layer of the touch display panel according to a known time-sharing manner.

FIG. 4 illustrates a drawing showing a waveform of a voltage applied to the common electrode (VCOM) layer of the touch display panel according to a first embodiment of the present invention.

FIG. 5 illustrates a drawing showing a waveform of a voltage applied to the common electrode (VCOM) layer of the touch display panel according to a second embodiment of the present invention.

FIG. 6 illustrates a drawing showing a waveform of a voltage applied to the common electrode (VCOM) layer of the touch display panel according to a third embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

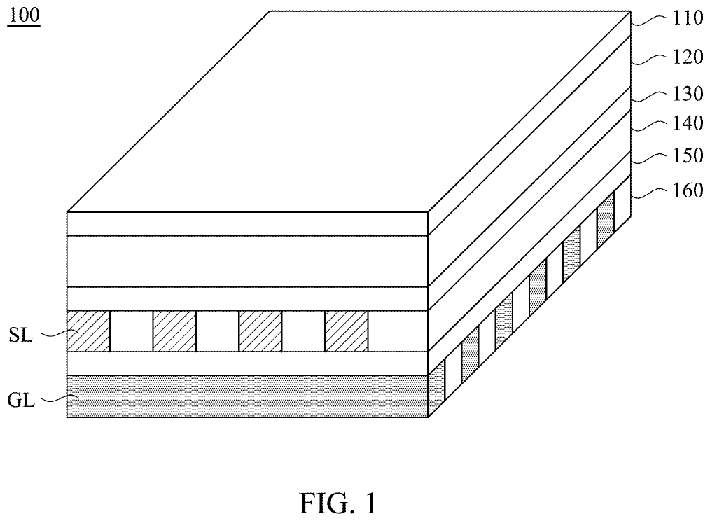

FIG. 1 illustrates a structural drawing of a touch display panel 100 according to some embodiments of the present invention. The touch display panel 100 includes three insulating layers 110, 130, and 150, a common electrode (VCOM) layer 120, and two touch sensing layers 140 and 160. The touch sensing layer 160 includes plural gate lines GL arranged along a lateral direction, and the touch sensing layer 140 plural source lines SL arranged along a longitudinal direction perpendicular to the lateral direction. The insulating layer 150 is disposed between the touch sensing layers 140 and 160. The common electrode (VCOM) layer 120 is disposed between the insulating layers 110 and 130.

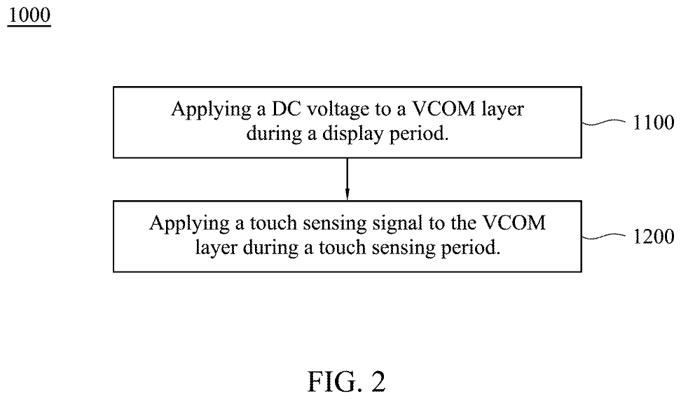

FIG. 2 illustrates driving method 1000 for reducing EMI of the touch display panel 100 according to some embodiments of the present invention. The driving method 1000 includes steps 1100 and 1200. In step 1100, a direct current (DC) voltage is applied to the common electrode (VCOM) layer 120 of the touch display panel 100 during a display period of the touch display panel 100. In step 1200, a touch sensing signal is applied to the common electrode (VCOM) layer 120 of the touch display panel 100 during a touch sensing period of the touch display panel 100.

In some embodiments of the present invention, the touch display panel 100 is an in-cell touch display panel. In the structure of the in-cell touch display panel, the self-capacitive and mutual-capacitive touch detection function is implemented though the common electrode (VCOM) layer 120 of the in-cell touch display panel. During the touch sensing period of the in-cell touch display panel, both of self-capacitive touch detection and mutual-capacitive touch detection need to apply a touch sensing signal to the common electrode (VCOM) layer. Specifically, the in-cell touch display panel utilizes a manner of VCOM division for self-capacitive and mutual-capacitive touch detection. The common electrode (VCOM) layer 120 is divided into plural small electrodes arranged in rows and columns, and each of the small electrodes could independently detect capacitance value to determine whether a touch event is occurred. The common electrode (VCOM) layer 120 needs to be utilized during the touch sensing period and during the display period of the in-cell touch display panel, in other words, the right for utilizing the common electrode (VCOM) layer alternately switches between the touch sensing period and the display period, and therefore the in-cell touch display panel needs to utilize the common electrode (VCOM) layer 120 in a time-sharing manner.

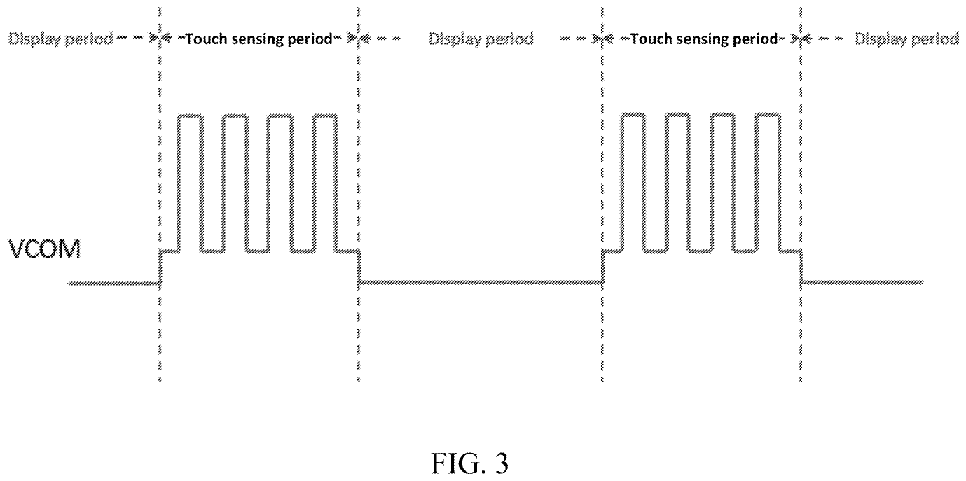

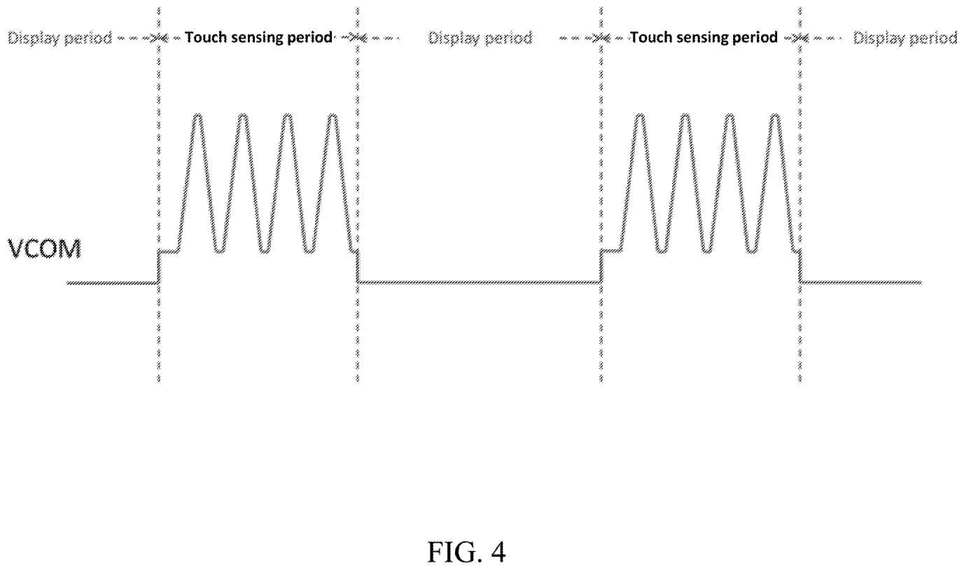

FIG. 3 illustrates a drawing showing a waveform of a voltage applied to the common electrode (VCOM) layer 120 of the touch display panel 100 according to a known time-sharing manner. As shown in FIG. 3, a direct current (DC) voltage is applied to the common electrode (VCOM) layer during the display period of the in-cell touch display panel, and the touch sensing signal which is a square wave is applied to the common electrode (VCOM) layer during the touch sensing period of the in-cell touch display panel. However, the frequency spectrum of the square wave contains the most harmonic contents, thereby generating severe electromagnetic interference (EMI). EMI must be avoided for electronic products, especially for vehicle products, and thus the vehicle products must have the lowest EMI. In order to reduce EMI, the voltage variation needs to be smooth as much as possible. The present invention discloses several waveforms (as shown in FIGS. 4-6) of the touch sensing signal for reducing EMI, and therefore the touch display panel applying the present invention could pass the EMI standard of the vehicle products.

FIG. 4 illustrates a drawing showing a waveform of a voltage applied to the common electrode (VCOM) layer 120 of the touch display panel 100 according to a first embodiment of the present invention. As shown in FIG. 4, a waveform of the touch sensing signal applied to the common electrode (VCOM) layer 120 of the touch display panel 100 during the touch sensing period of the touch display panel 100 is a triangle wave. The triangle wave can greatly reduce the voltage variation of the square wave, thereby reducing the even-harmonic interference of the square wave. Although the triangle wave can reduce the even-harmonic interference, the odd-harmonic interference still exists.

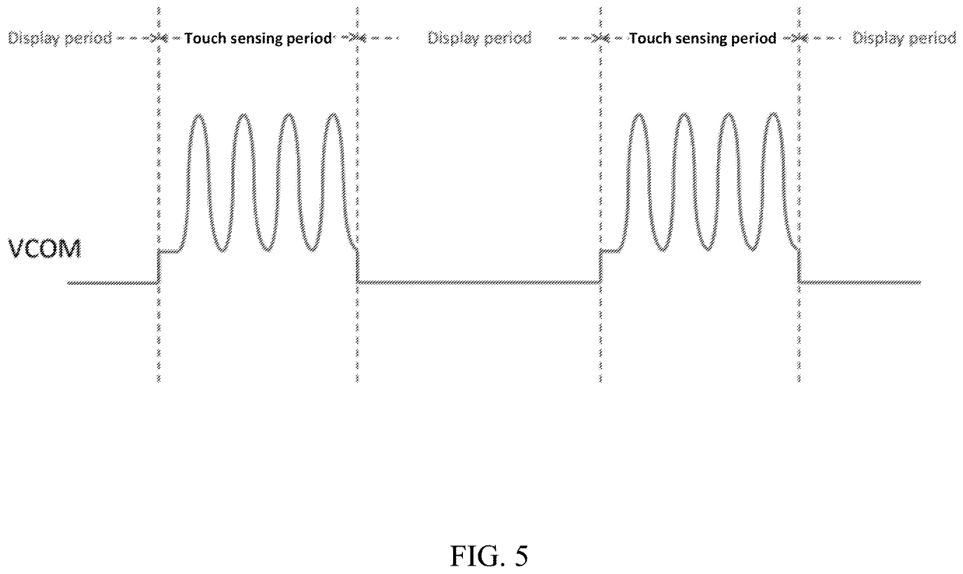

FIG. 5 illustrates a drawing showing a waveform of a voltage applied to the common electrode (VCOM) layer 120 of the touch display panel 100 according to a second embodiment of the present invention. As shown in FIG. 5, a waveform of the touch sensing signal applied to the common electrode (VCOM) layer 120 of the touch display panel 100 during the touch sensing period of the touch display panel 100 is a sine wave. The sine wave can further reduce the voltage variation of the triangle wave, thereby reducing the odd-harmonic interference of the triangle wave. As shown in FIG. 5, the sine wave is utilized during the touch sending period, and thus the harmonic interference during the touch sensing period can be greatly reduced. However, for example, the voltage level of the DC voltage applied to the common electrode (VCOM) layer 120 during the display period of FIG. 5 is −1 volt, and the voltage level of the touch sensing signal applied to the common electrode (VCOM) layer 120 during the touch sensing period of FIG. 5 is 0-5 volt. The waveform during transition progress for switching between the display period and the touch sensing period is not a continuous waveform, and therefore the sine wave applied to the common electrode (VCOM) layer 120 of the touch display panel 100 during the touch sensing period of the touch display panel 100 will still generate EMI during transition progress for switching between the display period and the touch sensing period.

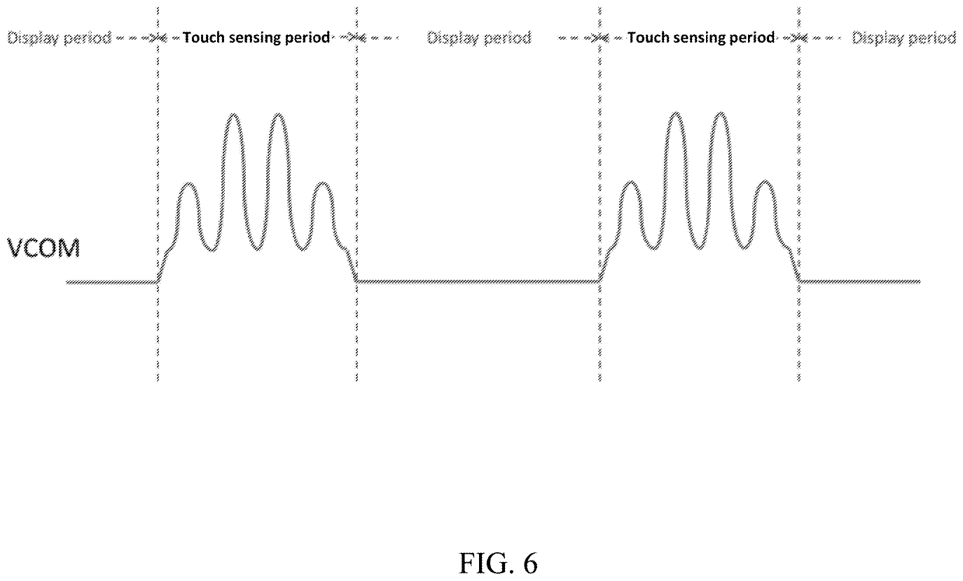

In order to reduce EMI as much as possible, a third embodiment of the present invention further discloses a waveform of the touch sensing signal for reducing discontinuity during transition progress for switching between the display period and the touch sensing period. FIG. 6 illustrates a drawing showing a waveform of a voltage applied to the common electrode (VCOM) layer 120 of the touch display panel 100 according to the third embodiment of the present invention. As shown in FIG. 6, a waveform of the touch sensing signal applied to the common electrode (VCOM) layer 120 of the touch display panel 100 during the touch sensing period of the touch display panel 100 is a sine wave truncated by a window function, thereby smoothing the waveform change during the transition progress for switching between the display period and the touch sensing period of the touch display panel 100, and therefore EMI can be further reduced. In the third embodiment of the present invention, the window function has a shape other than a rectangular shape, such that the touch sensing signal is gradually attenuated from a center portion to both ends of the touch sensing signal. As shown in FIG. 6, a discontinuity of voltage applied to the common electrode (VCOM) layer 120 of the touch display panel 100 during transition progress for switching between the display period and the touch sensing period is reduced.

In some embodiments of the present invention, the touch display panel 100 is an in-cell touch display panel. However, the present invention is not limited thereto, the touch display may be add-on touch display panel, such as an on-cell touch display panel. In some embodiments of the present invention, the touch display panel is a self-capacitive touch display panel or a mutual-capacitive touch display panel.

From the above description, the present invention provides a driving method for reducing EMI of a touch display panel. The waveform of the touch sensing signal applied to the common electrode (VCOM) layer of the touch display panel during the touch sensing period of the touch display panel is a triangle wave, a sine wave, or the sine wave truncated by a window function.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1-6. (canceled)

7. A driving method for reducing EMI of a touch display panel, wherein the touch display panel comprises a common electrode layer, wherein the driving method comprises:
applying a DC voltage to the common electrode layer during a display period of the touch display panel; and
applying a touch sensing signal to the common electrode layer during a touch sensing period of the touch display panel;
wherein a waveform of the touch sensing signal is a sine wave truncated by a window function.

8. The method of claim 7, wherein the touch display panel is an in-cell touch display panel.

9. The method of claim 7, wherein the touch display panel is a self-capacitive touch display panel or a mutual-capacitive touch display panel.

10. The method of claim 7, wherein the window function has a shape other than a rectangular shape, such that the touch sensing signal is gradually attenuated from a center portion to both ends of the touch sensing signal.
